(19) United States
(12) Patent Application Publication
(10) Pub. No.: US 2008/0202703 A1
(43) Pub. Date: Aug. 28, 2008

(54) Daylighting system comprising light re-direction elements in a Venetian blind

(76) Inventor: Ian Robert Edmonds, Kenmore Brisbane (AU)

Correspondence Address: BERENATO, WHITE & STAVISH, LLC, 6550 ROCK SPRING DRIVE, SUITE 240, BETHESDA, MD, 20817, US

(21) Appl. No.: 11/797,494

(22) Filed: May 3, 2007

(30) Foreign Application Priority Data
Feb. 28, 2007 (AU) 2007901018

(51) Int. Cl. E06B 9/386

(52) U.S. Cl. 160/168.1 R; 359/596

(57) ABSTRACT

A daylighting system comprising one or more light redirecting elements and a horizontal slat Venetian blind. The light redirecting elements are inserted between the slats of the Venetian blind and are supported between the slats and the outer strings of the Venetian blind. Each light redirecting element is a thin strip of reflective material formed into an angle section. The upper arm of the angle section reflects sunlight upwards through the Venetian blind and deeply into the interior of the building. The side arm of the angle section reflects sunlight back out of the window. The reflecting surface of an upper arm of a light redirecting element is treated to reflect light diffusely into a narrow angular range. The reflecting surface of a side arm of a light redirecting element is treated to reflect light diffusely into a wide angular range. The daylighting system is installed in the window of a building to redirect sunlight on to the ceiling of the building to improve natural illumination in the building.

### FIELD OF THE INVENTION

This invention when installed in a window redirects sunlight over the ceiling of a building to improve natural illumination in the deep interior of the building.

### BACKGROUND

In sunny climates the radiant heat through windows must be controlled to avoid excessive heating of buildings and excessive cooling loads. A horizontal louver is an effective means of controlling the input of radiant heat through a window. The common name for a variable tilt horizontal louver slat blind is louver blind or Venetian blind. The Venetian blind is one of the most commonly used and inexpensive means for controlling radiant heat gain through windows. However, tilting a Venetian blind to block radiant input compromises the ability of the Venetian blind to redirect natural light into the deep interior of buildings. The reason for this is illustrated in the section view of a Venetian blind, FIG. 1. A typical Venetian blind comprises an array of opaque slats 1 supported by strings 4 running between vertical inner supporting strings 2 and outer supporting strings 3. Outer supporting strings 3 being the strings closest to the window glass 14. Sunlight 8 incident through window glass 14 is blocked by the slats 1 and diffusely reflected into a wide range of directions 11. A proportion of this sunlight is reflected to the outside, a proportion is inter-reflected between the slats 1 and is absorbed by the blind and a proportion is reflected into the building illuminating the region of the room close to the louver blind. The relative proportions of light reflected to the outside and inside depend on the tilt, spacing, curvature and reflectance of the blind slats. It may be noted that when tilted to block incoming sunlight the Venetian blind still allows a reasonable view to the outside as illustrated by ray path 10 in FIG. 1.

The objective of the present invention is to improve the daylighting performance of a conventional Venetian blind so that a much higher proportion of the incoming natural light is redirected through the blind and over the ceiling in the deep interior of the building.

A considerable amount of prior art relates to horizontal louver type systems for installation in windows to improve daylighting. Bartenbach, U.S. Pat. No. 5,388,000 describes a louver of concave, partly perforated reflectors. Zillig, U.S. Pat. No. 4,351,588 describes a louver of reflectors, concave on the upper surface and V shaped planar on the lower surface, that can be rotated between double glazing for daylighting a room. Bartenbach, U.S. Pat. No. 5,517,960 describes a louver of slats containing prismatic rods. Koster U.S. Pat. Nos. 6,240,999, 6,367,937 and 6,845,805 describes louvers of complex shape designed to reject specific angular ranges of light and admit other angular ranges of light. All the prior art mentioned above require the installation of specialized louvered arrangements for the redirection of daylight. In particular none of the prior art teaches the use of the familiar and commonly available Venetian blind as an integral part of a daylighting system. Further the louver elements outlined in the prior art are complex in shape having a multiplicity of surfaces, up to ten surfaces in the case of Kosters designs, or perforated surfaces or specialized surfaces such as prismatic surfaces or surfaces with prismatic rods. None of these prior art systems are suited to conversion of a standard Venetian blind but would require replacement of a standard Venetian blind with the particular specialized louver system.

### SUMMARY OF THE INVENTION

The daylighting system of this invention comprises one or more light redirecting elements inserted between the slats of a conventional Venetian blind. The slats of the Venetian blind are tilted so that a light redirecting element can be supported gravitationally between a slat and the outer support strings of the Venetian blind. Each light redirecting element is a strip of reflective material formed into an angle section. The upper arm of the angle section reflects sunlight upwards through the Venetian blind and deeply into the interior of the building. The near vertical side arm of the angle section reflects sunlight downwards and back out of the window. The reflecting surface of the upper arm of the light redirecting element is treated to difflusely reflect the sunlight into a narrow angular range centered on the specular direction of reflection. The reflecting surface of the side arm is treated to diffusely reflect sunlight into a wide angular range.

### BRIEF DESCRIPTION OF THE DRAWINGS

FIG. 1. A section view of a conventional Venetian blind.

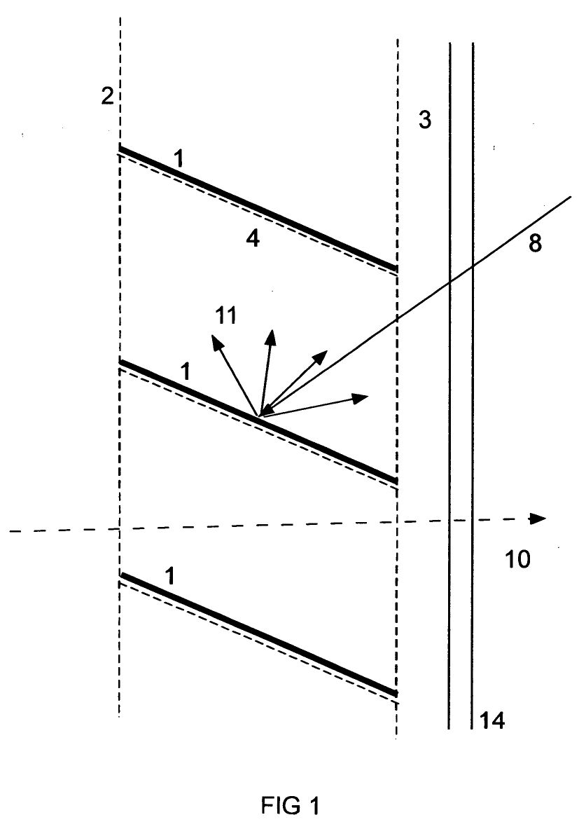

FIG. 2 A schematic view of the light redirecting element of this invention

FIG. 3. A section view showing light redirecting elements inserted into a conventional Venetian blind.

FIG. 4. A section view illustrating the difflusion of reflected light by the light redirecting elements.

FIG. 5. A section view illustrating the performance of the daylighting system of this invention when installed in the window of a room.

### DETAILED DESCRIPTION OF THE INVENTION

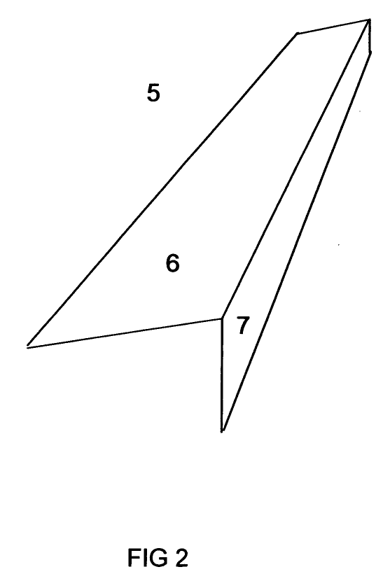

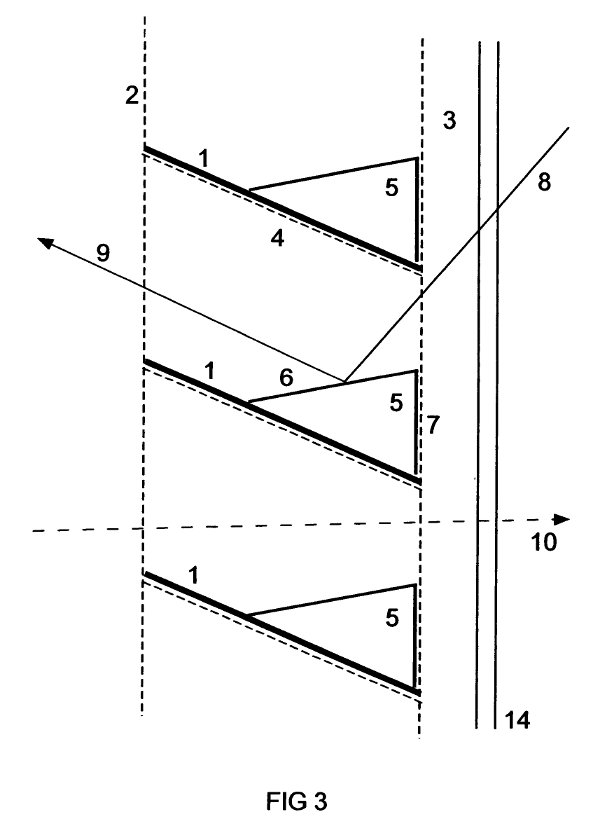

As illustrated in FIG. 2 the light redirecting elements 5 of this invention comprise strips of reflective material folded into an angle section comprising an upper arm 6 and a near vertical side arm 7. The fold of the reflective strip is such as to produce an acute angle between arm 6 and arm 7. The acute angle is in the range 60° to 90° degrees and is typically about 70°. The other dimensions of the light redirecting element depend on the dimensions of the Venetian blind into which the element will be inserted to form the daylighting system. The dimensions of a basic Venetian blind are defined by the width, a, of the slats and the spacing, b, between the slats. The dimensions of the light redirecting elements 5 relative to the dimensions of the combining Venetian blind are: width of the upper arm 6 is in the range 0.3 to 0.7 of the width of the Venetian blind slat, that is between 0.3a and 0.7a, and the width of the side arm 7 is in the range 0.3 to 0.7 of the spacing between the slats, that is between 0.3b and 0.7b. The exact width of the arms of the light redirecting elements 5 are not critical to the functioning of the daylighting system. For example, as the width of the upper arm 6 varies in the range 0.3a to 0.7a the amount of sunlight redirected into the interior increases in roughly the same proportion. The overall length of the elements is substantially the same length as the length of the Venetian blind slat. However, for ease of insertion the light redirecting elements may be made shorter in length than the length of the slats. For example, the length of the light redirecting elements may be made substantially one half the length of the Venetian blind slats with two such elements inserted end to end between the slats so that the redirecting surfaces extend over the total length of the slats. The light redirecting elements 5 of this invention are inserted between the slats 1 of a Venetian blind as illustrated in FIG. 3 to form the daylighting system. A redirecting element 5 is inserted to the window side of the Venetian blind and is supported in position by the tilted slat 1 and the outer supporting string 3. Typically, in sunlight, the tilt of the slat of the Venetian blind would be in the range 10 to 30 degrees from horizontal to provide the blind with a radiant heat blocking function. With the slats tilted in the range 10 to 30 degrees the light redirecting elements are located in place between the slat surface and the outer supporting strings 3. Sunlight ray 8 is reflected from the surface of arm 6 of the element 5 into an output ray 9 that transfers sunlight through the blind and into the interior. The formation of the light redirecting elements 5 by folding is a simple way of producing an angle section with an upper arm 6 and a side arm 7 from thin sheet metal or metal foil. However, an angle section with an upper arm and a side arm may be formed by other methods such as extrusion of a metal such as aluminum or extrusion of a plastic such as poly vinyl chloride. Similarly the functional angle section could be part of a triangle section rather than a simple angle section with the triangle section having the required and functional upper arm and side arm as well as a non-functional lower arm.

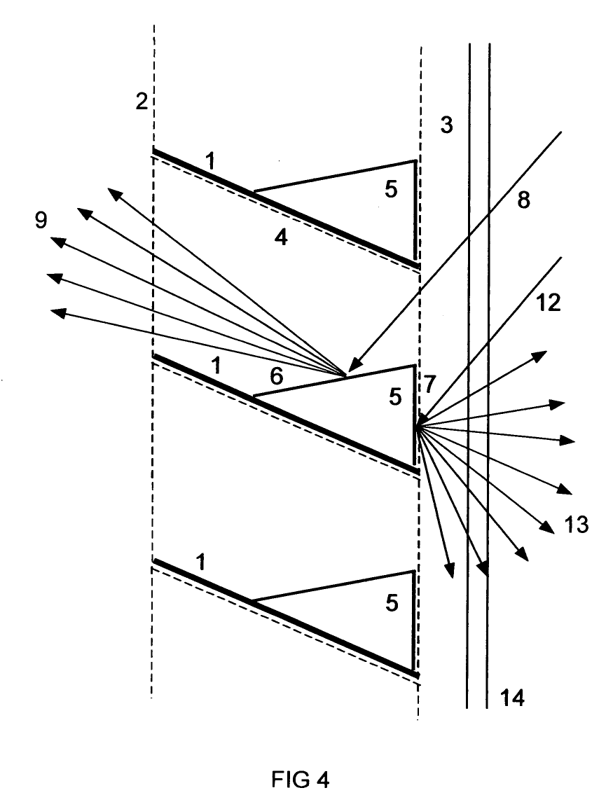

An important feature of this invention is the treatment of the reflective upper surface of arm 6 and the treatment of the reflective side surface of arm 7 of the redirecting elements 5 as this determines how the sunlight is redirected by arm 6 through the daylighting system and into the room and also how the remaining sunlight is redirected by arm 7 back out of the building. In general, a first treatment is applied to make the upper reflective surface of arm 6 reflect difflusely into a narrow angular range, typically about 10 degrees angular width on either side of the direction of specular reflection. A second and different treatment is applied to make arm 7 reflect into a wide angular range. The desired effect of the treatment of the surfaces of arms 6 and 7 of the elements 5 is illustrated in FIG. 4 which shows a section view of a Venetian blind with redirecting elements 5 inserted in the blind. Sunlight rays 8 and 12 are incident on the element 5 from outside the window 14 in which the daylighting system is installed. Sunlight ray 8 is diffusely reflected by the upper surface of arm 6 into a light output of narrow angular width 9 that is transmitted onto the ceiling of the room to be illuminated. Sunlight ray 12 is diffusely reflected by the surface of the near vertical arm 7 into a light output of wide angular width 13 that is transmitted out through the window 14 against which the daylighting system is installed.

In one preferred embodiment of the invention the treatment of the metal surface of arm 6 of the redirecting elements 5 is a uni-directional roughening of the surface to make the surface diffusely reflecting in the vertical plane. That is, the reflected light is spread, up and down, in the vertical plane that contains the incident light ray but is not significantly spread, sideways, in the horizontal plane. The uni-directional roughening can be achieved by roughening the surface of arm 6 by lightly sanding the surface along the length of the element 5 with fine emery paper. Alternatively the uni-directional roughening can be achieved by uni-directional rolling of the reflective strip prior to folding into an angle section. When the reflective strip is comprised of thin metal that has been formed into a thin sheet by rolling the intrinsic uni-directional surface roughness associated with the rolling process can provide the desired diffuse reflectance of the surface of arm 6 of the element.

In a second embodiment of the invention the diffusion of reflected light from the surface of arm 6 is achieved by forming the arm 6 with a slight upward convex curvature prior to or after folding into an angle section.

In a third embodiment the diffusion of reflected light from the surface of arm 6 is achieved by a fine general roughening of the metal forming the surface of arm 6 or by painting the surface of arm 6 with a high gloss white paint.

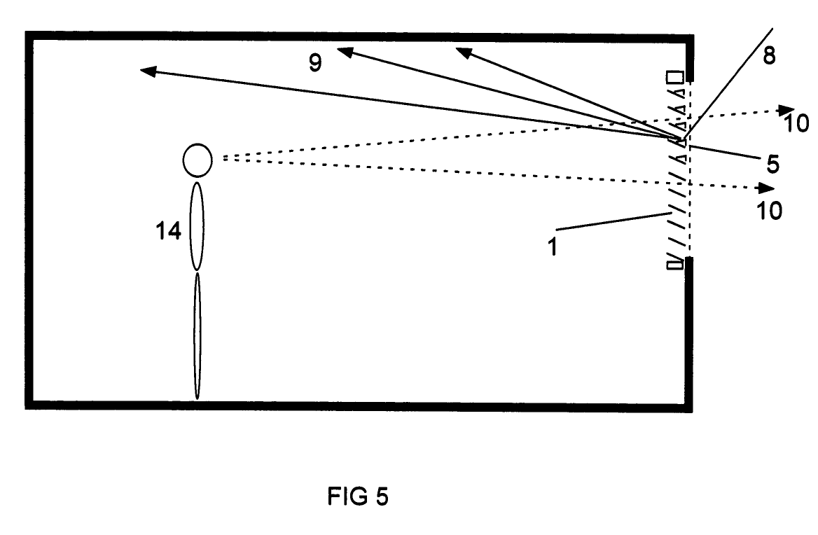

The purpose of diffusely reflecting sunlight from upper arm 6 of the light redirecting elements 5 is to spread the sunlight reflected from each light redirecting element over a wide extent of the ceiling of the room being illuminated. This desired effect is illustrated in FIG. 5 which shows the daylighting system of this invention installed in the window of a room. As indicated in FIG. 5 light redirecting elements 5 are inserted between the slats in the upper half of the Venetian blind. The reason for insertion only in the upper half of the blind is explained below. Typically, incident sunlight 8 is diffusely reflected from upper arm 6 of each of the elements into an output 9 that is spread over a wide extent of the ceiling of the room. As the diffluse reflected light is of narrow angular extent and as the inner part of slat 1 blocks light reflected below horizontal, the light output 9 into the room is substantially all above horizontal and, therefore, does not constitute a glare source for occupants in the room. A primary reason for placing the light redirecting elements only in the upper part of the louver blind is that, ideally, the lowest redirecting element inserted in the louver blind should be at or above head height of a standing occupant so as to avoid upwardly reflected light from the element entering the view of the occupant. A view out of the room through the daylighting system is provided to occupants as illustrated by rays 10 in FIG. 5.

The purpose of difflusely reflecting sunlight at the near vertical side arm 7 of the light redirecting elements is to reduce the potential of reflected sunlight from the side arm becoming a source of glare discomfort for people outside the building. Any surface treatment that diffluses or spreads the reflected light into a wide angular range will achieve this purpose. Thus a general roughening rather than a uni-directional roughening will achieve the desired effect. A general roughening producing a diffuse reflectance of wide angular extent can be achieved by circular sanding the surfaces of the light redirecting element 5 with coarse emery paper or by sand blasting the surface or by painting the surface to achieve a low gloss or matt finish on the surface.

The redirection of sunlight deep into a room is determined by the acute angle between the upper arm 6 and side arm 7 of the light redirecting elements 5 and the tilt of the louver slats 1. For example, in FIG. 3 sunlight 8 incident from elevation about 50° is reflected by the upper arm 6 of a redirecting element set at about 15° from horizontal into an output ray 9 at elevation about 20° above horizontal. The depth to which sunlight can be reflected into a room can be adjusted by altering the tilt angle of the Venetian blind through a small angle. For example, adjusting the tilt through 5° inwards lowers the angle of the light redirected into the room through 10°. However, maintaining a tilt of the louvers of the Venetian blind that blocks most of the sunlight incident on the lower part of the blind not containing light redirecting elements 5 is desirable in order to reduce radiant input to the building. A louver tilt from horizontal in the range 10 to 30 degrees is suitable for blocking a high proportion of the sunlight incident on the lower part of the blind. The relative amount of sunlight admitted and redirected by elements 5 deep into the room can be adjusted by varying ratio of the height of the upper part of the Venetian blind containing light redirection elements to the height of the lower part without light redirecting elements. In effect the shading coefficient of the daylighting system of this invention can be varied by varying this height ratio. A first approximation estimate of the shading coefficient of this daylighting system can be made as follows. Suppose redirecting elements occupy all of the upper half of the Venetian blind. Reference to FIG. 4 indicates that about one half of the sunlight through that part of the blind with redirecting elements will be redirected deeply into the room with the other half of sunlight blocked by the side arms 7 of the elements 5. Thus the shading coefficient of this upper half of the blind will be about 0.5. The lower half of the blind can, as a first approximation, be taken to block all sunlight and therefore have a shading coefficient of zero. The overall shading coefficient of the system, taking into account the upper and lower halves of the blind is then 0.25. That is, ¾ of the sunlight incident on the daylighting system is rejected or blocked and ¼ is redirected deep into the room and over the ceiling. While a fraction of ¼ of sunlight admitted by a daylighting system may seem low the ¼ fraction that is admitted is delivered optimally to the room. That is, it is delivered onto the ceiling in the deep interior of the room.

The above analysis can be extended to give an approximate estimate of lighting performance in direct sunlight. Referring to FIG. 5, suppose the room is 3 m high, the window is 2 m high and light redirecting elements are in the top half of the Venetian blind. The one metre high top half will redirect about 50% of the incident sunlight deeply into the room. The one metre high lower half will, as a first approximation, block all sunlight. In direct sunlight the normal light flux is about 100,000 lumens per square metre. For sunlight incident in the normal plane at 45° elevation the incident flux on the daylighting system is about 70,000 lumens per square metre. Thus, for each metre width of daylighting system about 35,000 lumens is redirected through the upper half of the daylighting system and over the ceiling of the room. Provided the ceiling is highly reflective, for example if the ceiling is painted matt white, most of the 35,000 lumens will be diffusely reflected down to illuminate work surfaces in the room.

The luminance of a conventional Venetian blind, as observed by an occupant, can be high in direct sunlight if the slats are highly reflecting, for example if the slats are white. The high luminance may give rise to discomfort glare and may have an adverse effect on the visibility of computer screens being viewed within a room with Venetian blinds. This problem can be reduced by using Venetian blinds of a darker color, for example blue, green, brown or wooden blinds. However, now the daylighting performance of a dark colored conventional Venetian blind is further reduced below that of a white colored conventional Venetian blind. The daylighting system of this invention circumvents this problem as, in the daylighting system of this invention, the transfer of daylight to the interior is largely independent of the color of the slats of the combining Venetian blind. Referring to FIG. 4 or FIG. 5, the daylight transferred to the interior 9 is reflected from the surface of the top arm 6 of the redirecting element 5. This light does not provide a significant luminance problem for computer screens as it illuminates the ceiling resulting in a ceiling of high luminance. Bright sources on the ceiling are much less of a luminance problem when viewing computer screens than windows or blinds are as computer screens are close to vertical and the reflected images of the ceiling are much less observable in the screens than the reflected images of windows or blinds. Where colored Venetian blinds are used as part of the daylighting system of this invention it may be desirable for aesthetic reasons that the surface of the near vertical arm 7 of the redirecting elements 5 be treated with matt finish paint of the same color as the color of the Venetian blind. Alternatively, if aesthetics is not a primary concern, the arm 7 may be finished in matt white paint to enhance the radiant heat rejection of the daylighting system.

The advantages of the daylighting system of this invention may be summarized as follows. In addition to the good interior shading typical of a Venetian blind this invention provides good daylighting of the building. Sunlight is redirected by this daylighting system over the ceiling deep inside the building to provide diffuse downward illumination from the ceiling to work surfaces deep in the building. The redirected sunlight is not a glare source to occupants as any sunlight reflected from the upper arm 6 of the redirecting elements in a downward direction is blocked by the inner part of the tilted slat 1. The daylighting system itself, as viewed by an occupant, has less luminance than a conventional Venetian blind due to the fact that sunlight is redirected by the light redirecting elements through the blind rather than being reflected onto the lower side of the slats. As a result the lower side of the slats, which is visible from the interior, is much less luminous than would be the case in a conventional Venetian blind set at the same tilt. This has advantages in respect to occupant comfort and the viewing of video screens. This advantage can be further enhanced by using a dark colored blind rather than a white colored blind as, in the daylighting system of this invention, the daylighting function is largely independent of the color of the combining Venetian blind. The shading or radiant heat rejection performance associated with this daylighting system is an improvement on that available with a conventional Venetian blind as the near vertical side arm 7 of the light redirecting elements reflects sunlight directly to the outside whereas in a conventional Venetian blind much of the incident sunlight is inter-reflected between adjacent slats and enters the room or is absorbed in the blind itself. The light reflecting elements that form one part of this daylighting system are simple to manufacture and are inexpensive. The Venetian blind that forms the other part of this daylighting system is commonly available. Where Venetian blinds have been previously installed in a building it may be possible to upgrade the daylighting performance of the building by adding light redirecting elements to the existing Venetian blinds in order to create the daylighting system of this invention. To an occupant inside a building the daylighting system of this invention looks almost exactly the same as a conventional venetian blind except for reduced luminance of the part of the daylighting system with light redirecting elements. Therefore this daylighting system can be installed in a building with the only significant change to the internal appearance of the building being the distribution of sunlight over the ceiling of the room. Further, the sunlight moves across the ceiling during the day. From the point of view of the occupants this is unusual as sunlight normally moves across the floor or across work surfaces in a building. It may be expected, however, that with the benefits of improved natural lighting, improved radiant heat rejection and reduced reflected glare associated with this daylighting system occupants will quickly adapt to the distribution of sunlight on the ceilings of their buildings.

I claim:

1. A daylighting system comprising one or more light redirecting elements and a horizontal slat Venetian blind, said light redirecting elements being inserted between one or more adjacent pairs of slats of the Venetian blind, the horizontal slats being tilted through an angle substantially in the range 10 to 40 degrees so that a light redirecting element can be supported gravitationally between a slat and the outer support strings of the Venetian blind, said light redirecting elements being thin metal or plastic formed into a section having an upper arm of width 0.3 to 0.7 of the width of the slats of the Venetian blind and a side arm of width substantially 0.3 to 0.7 of the spacing between the slats of the Venetian blind, the angle between the upper arm and the side arm of a light redirecting element being an acute angle in the range 60 to 90 degrees, the length of a light redirecting element being substantially equal to the length of the slats of the Venetian blind or the length of a light redirecting element being such that two, three or more light redirecting elements when inserted end to end between the slats of the Venetian blind substantially equal the length of the slats of the Venetian blind, the outer surface of the upper arm of a light redirecting element having surface treatment to difflusely reflect light into a narrow angular range centered substantially on the specular direction of light reflection and the outer surface of the side arm of a light redirecting element having surface treatment to diffusely reflect light into a wide angular range, said daylighting system being installed in a window of a building to redirect sunlight on to the ceiling of the building to increase the natural illumination inside the building.

2. A daylighting system as in claim 1 having the outer surface of the upper arm of one or more of the light redirecting elements made difflusely reflecting by uni-directional sanding or rolling or roughening of the outer surface along the direction of the length of the light redirecting elements.

3. A daylighting system as in claim 1 having the outer surface of the upper arm of one or more of the light redirecting elements made diffusely reflecting by giving a slight convex curvature to the upper arm.

4. A daylighting system as in claim 1 having the outer surface of the upper arm of one or more of the light redirecting elements made diffusely reflecting by treating the outer surface of the upper arm with a fine general sanding or a fine sand blasting or by painting with gloss finish white paint.

5. A daylighting system as in claim 1 having the outer surface of the side arm of one or more the light redirecting elements made diffusely reflecting into a wide angular range by painting with matt finish paint.
